(19) United States
(12) Patent Application Publication
(10) Pub. No.: US 2008/0084803 A1
(43) Pub. Date: Apr. 10, 2008

(54) Optical Disc Access Apparatus for Evaluating a Disc and Method Thereof

(75) Inventors: Shih-Hao Chen, Hsinchu City (TW); Pin-Chou Liu, Taipei County (TW); Sung-Yang Wu, Hsinchu City (TW); Ping-Tsai Tsai, Kaohsiung County (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu City (TW)

(21) Appl. No.: 11/538,563

(22) Filed: Oct. 4, 2006

(51) Int. Cl. G11B 7/00

(52) U.S. Cl. 369/53.22

(57) ABSTRACT

Disc data accessing in current disc drives is time consuming to the user and generally inefficient. The optical disc evaluation method and access apparatus for evaluating compatibility between a disc and a disc drive described herein was created and designed to increase efficiency during disc accessing. The optical disc access apparatus comprises of a receiver and an optical disc scoring unit. The receiver is configured for retrieving a reflected signal from a disc while the optical disc scoring unit is configured for generating information in response to the reflected signal. The resulting information indicates the compatibility between the disc and disc drive.

### CROSS-REFERENCES TO RELATED APPLICATIONS

Not applicable.

### BACKGROUND OF THE INVENTION

1. Field of the Invention

The present invention relates to an optical disc access apparatus for evaluating a disc and the method thereof. More particularly, the present invention relates to an optical disc access apparatus for evaluating compatibility between a disc and a disc drive when accessing and the method thereof.

2. Descriptions of the Related Art

When a user inserts a disc into a disc drive, the disc drive starts to read data from the disc. If the disc is not compatible with the disc drive, or the disc is damaged or scratched on the surface, the disc drive cannot read the disc smoothly, which may prevent the disc drive from reading the disc.

Conventionally, when a user inserts a disc into the disc drive, a small animated icon in the shape of a disc is displayed to indicate the disc readability status. If the disc can be read, then the disc drive may start to display programs of the disc, or a select menu may show on the display for further operation in a manner of DVD playing. If the disc drive fails to read the disc, a notification of disc incompatibility may be displayed.

However, the user must wait to know if the disc is able to be read by the disc drive even after the disc drive has tried to read the disc. Moreover, the disc drive reads every disc in the same procedure, regardless of the storage format of the disc, further increasing the waiting time.

Therefore, an optical disc access apparatus and method for evaluating compatibility between disc media and disc drives through the adjustment of accessing parameters are needed by the disc media industry.

### SUMMARY OF THE INVENTION

The primary objective of this invention is to provide an optical disc evaluation method for evaluating compatibility between a disc and a disc drive when accessing. The optical disc evaluation method comprises steps of: retrieving a reflected signal from the disc; and generating information in response to the reflected signal. The information indicates the compatibility.

Another objective of this invention is to provide an optical disc access apparatus for evaluating compatibility between a disc and a disc drive. The optical disc access apparatus comprises a receiver and an optical disc scoring unit. The receiver is configured for retrieving a reflected signal from a disc. The optical disc scoring unit is configured for generating information in response to the reflected signal. The information indicates the compatibility.

Another objective of this invention is to provide an optical disc access apparatus for evaluating compatibility between a disc and a disc drive. The optical disc access apparatus comprises means for retrieving a reflected signal from a disc; and means for generating information in response to the reflected signal. The information indicates the compatibility.

Yet a further objective of this invention is to provide a disc drive. The disc drive comprises a receiver and an optical disc scoring unit. The receiver is configured for retrieving a reflected signal from a disc. The optical disc scoring unit is configured for generating information in response to the reflected signal. The information indicates compatibility between the disc and the disc drive, the disc drive is capable of at least one of digital video recorder, CD player, Blu-ray, and HD-DVD player.

While the disc drive accesses the disc, the compatibility evaluation of the disc and the disc drive is used to adjust accessing parameters of the disc drive.

The detailed technology and preferred embodiments that arise from the subject invention are described in the following paragraphs accompanying the appended drawings for people skilled in this field to well appreciate the features of the claimed invention.

### BRIEF DESCRIPTION OF THE DRAWINGS

FIG. 1 is a block diagram of a first embodiment of the present invention; and

FIG. 2 is a procedure chart of a second embodiment of the present invention.

### DESCRIPTION OF THE PREFERRED EMBODIMENT

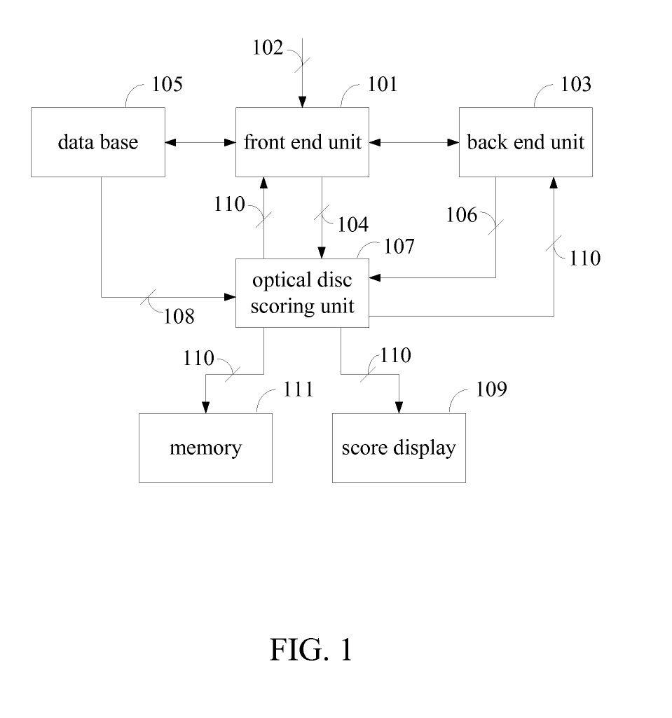

FIG. 1 shows a block diagram of a first embodiment of the present invention. A disc drive comprises a front end unit 101, a back end unit 103, a data base 105, an optical disc scoring unit 107, a score display 109, and a memory 111. The disc drive is compatible with, but is not limited to, at least one of the following formats: digital video recorder, CD player, DVD-player, Blu-ray, and HD-DVD player. Generally, the front end part of a disc drive is configured for servo control, and the back end part of the disc drive is configured for multimedia data processing. The front end unit 101 comprises a receiver for retrieving a reflected signal 102 reflected from a disc. The back end unit 103 receives the reflected signal 102 from the front end unit 101. The reflected signal 102 carries physically readable signals and status such as an asymmetry value, a bit error rate (BER), a jitter, a pit/land length deviation, a data-to-clock edge deviation, a RF signal, a differential push-pull (DPP) signal, and Wobble frequency. The front end unit 101 then generates a front end quality indicator 104 related to the servo control quality according to the reflected signal 102. The back end unit generates a back end quality indicator 106 related to the multimedia data playing quality according to the reflected signal 102. The data base 105 stores a plurality of disc character data. When the data base 105 receives a character signal from the front end unit 101 indicating characters of the disc according to the reflected signal 102, it generates a disc indicator 108 according to the disc character data and the character signal.

The optical disc scoring unit 107 then generates information 110 according to the front end quality indicator 104, the back end quality indicator 106 and the disc indicator 108. The information 110 indicates compatibility between the disc and the disc drive. The front end unit 101 and the back end unit 103 then adjust the accessing parameters of the disc drive and process the disc in one of the predetermined procedures in response to the information 110. For example, the information 110 may contain a value, once the value is lower than a predetermined threshold value, which means the disc is not compatible with the disc drive and cannot be read smoothly. The disc drive then stops trying to read the disc and enables a controller to open a tray of the disc drive. The information 110 may also indicate a low RF signal, which means the pick-up head of the disc drive is not on a normal focusing position to read data from the disc. The disc drive then adjusts its accessing parameter to set the pick-up head back to the normal focusing position. The information 110 may also indicate the BER. If the BER is high, it means the disc drive has to execute a correction procedure to correct data read from the disc. If the BER is low, which means the read data is mostly correct, the disc drive may skip the correction procedure and directly execute and play data read from the disc.

The score display 109 then receives the information 110 from the optical disc scoring unit 107 and presents the information 110 through an audio message or a video message to notify the user of the compatibility between the disc and the disc drive. The information 110 is also stored in a memory 111.

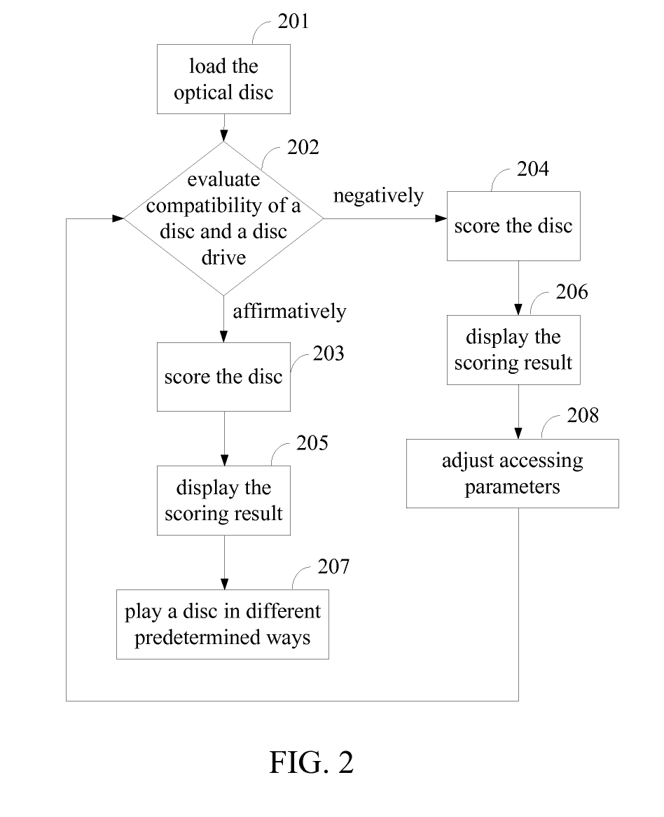

FIG. 2 shows a procedure chart of a second embodiment of the present invention. The second embodiment is a DVD player having a scoring unit. In the step 201, an optical disc is inserted in the DVD player. In the step 202, the DVD player starts to evaluate compatibility between a disc and the DVD player according to a front end quality indicator, a back end quality indicator, and a disc indicator. If the evaluation responds affirmatively, which means the disc and the disc drive are compatible with each other, the step 203 is executed to score the disc and store the scoring result to a memory. In the step 205, the scoring result is presented in an audio message or a video message. In the step 207, the disc is played in a predetermined procedure according to the scoring result.

If the evaluation in the step 202 responds negatively, which means the disc and the disc drive are not compatible with each other, then the step 204 is executed to score the disc and store the scoring result to a memory. In the step 206, the scoring result is presented in an audio message or a video message. In the step 208, accessing parameters of the DVD player are adjusted to read the disc. Then step 202 is executed to evaluate the disc again.

In addition to the steps shown in FIG. 2, the second embodiment is able to execute all of the operations or functions noted in the first embodiment. The methods in which the DVD player unit performs the operations and functions based on the above descriptions can be inferred from the descriptions of the first embodiment. Therefore, the descriptions for these operations and functions are redundant and not included herein.

The present invention provides a solution for evaluating compatibility between the disc and the disc drive when the disc drive accesses the disc, so that the disc drive can play the disc in different predetermined procedures and adjust accessing parameters according to the scoring result.

The above disclosure is related to the detailed technical contents and inventive features thereof. People skilled in this field may proceed with a variety of modifications and replacements based on the disclosures and suggestions of the invention as described without departing from the characteristics thereof. Though such modifications and replacements are not fully disclosed in the above descriptions, they have substantially been covered in the following claims as appended.

What is claimed is:

1. A method for evaluating compatibility between a disc and a disc drive, comprising the steps of:
retrieving a reflected signal from the disc; and
generating information in response to the reflected signal;
wherein the information indicates the compatibility.

2. The method as claimed in claim 1, wherein the information includes at least one of bit error rate, PIPO, asymmetry value, jitter, pit/land length deviation, data-to-clock edge deviation, RF signal, differential push-pull (DPP) signal, and Wobble frequency.

3. The method as claimed in claim 1, wherein the information is generated according to a front end quality indicator.

4. The method as claimed in claim 1, wherein the information is generated according to a back end quality indicator.

5. The method as claimed in claim 1, wherein the information is generated according to a database.

6. The method as claimed in claim 1, further comprising a step of presenting contents related to the information.

7. The method as claimed in claim 6, wherein the contents are presented through an audio message.

8. The method as claimed in claim 6, wherein the contents are presented through a video message.

9. The method as claimed in claim 1, further comprising a step of opening a tray of the disc drive if the information is lower than a predetermined threshold value.

10. The method as claimed in claim 1, further comprising a step of adjusting an accessing parameter of the disc drive in response to the information.

11. The method as claimed in claim 1, further comprising a step of accessing to the disc in one of predetermined ways in response to the information

12. The method as claimed in claim 1, further comprising a step of storing the information.

13. An apparatus for evaluating compatibility between a disc and a disc drive, comprising:
a receiver for retrieving a reflected signal from a disc; and
an optical disc scoring unit for generating information in response to the reflected signal,
wherein the information indicates the compatibility.

14. The apparatus as claimed in claim 13, wherein the information includes at least one of bit error rate, PIPO, asymmetry value, jitter, pit/land length deviation, data-to-clock edge deviation, RF signal, differential push-pull (DPP) signal, and Wobble frequency.

15. The apparatus as claimed in claim 13, wherein the optical disc scoring unit generates the information according to a front end quality indicator.

16. The apparatus as claimed in claim 13, wherein the optical disc scoring unit generates the information according to a back end quality indicator.

17. The apparatus as claimed in claim 13, wherein the optical disc scoring unit generates the information according to a database.

18. The apparatus as claimed in claim 13, further comprising a display receiving the information and presenting contents related to the information.

19. The apparatus as claimed in claim 18, wherein the display presents the contents through an audio message.

20. The apparatus as claimed in claim 18, wherein the display presents the contents through a video message.

21. The apparatus as claimed in claim 13, further comprising a controller for opening a tray of the disc drive if the information is lower than a predetermined threshold value.

22. The apparatus as claimed in claim 13, further comprises a controller for adjusting an accessing parameter of the disc drive in response to the information.

23. The apparatus as claimed in claim 13, wherein the disc drive processes the disc in one of predetermined ways in response to the information.

24. The apparatus as claimed in claim 1, further comprising a memory for storing the information.

25. An optical disc access apparatus for evaluating compatibility between a disc and a disc drive, comprising:
means for retrieving a reflected signal from a disc; and
means for generating information in response to the reflected signal,
wherein the information indicates the compatibility.

26. A disc drive, comprising:
a receiver for retrieving a reflected signal from a disc; and
an optical disc scoring unit for generating information in response to the reflected signal,
wherein the information indicates compatibility between the disc and the disc drive, the disc drive is associated with at least one of a digital video recorder, a CD player, a DVD player, a Blu-ray, and a HD-DVD player.
